(19) United States
(12) Patent Application Publication
(10) Pub. No.: US 2021/0006472 A1
(43) Pub. Date: Jan. 7, 2021

(54) Method For Managing Resources On One Or More Cloud Platforms

(71) Applicant: Hewlett Packard Enterprise Development LP, Houston, TX (US)

(72) Inventors: Priyatham Khaspa, Bangalore Karnataka (IN); Prabhu Murthy, Bangalore Karnataka (IN); Shruthi Patil, Bangalore Karnataka (IN)

(21) Appl. No.: 16/460,304

(22) Filed: Jul. 2, 2019

(51) Int. Cl. H04L 12/24; G06N 20/00; H04L 12/911; H04L 29/08

(52) U.S. Cl. CPC H04L 41/145; H04L 67/10; H04L 47/70; G06N 20/00

(57) ABSTRACT

The current disclosure describes a method for managing a plurality of resources associated with one or more user, hosted in one or more cloud platforms. The method comprises receiving resource utilization data associated with the plurality of resources and event data associated one or more user applications of the users, identifying one or more resources to be freed, based on resource utilization data and event data using a resource management model, identifying a set of resources related with each resource from the one or more resources and releasing each resource from the one or more resources and the set of related resources related with the corresponding each resource from the one or more resources. The resource management model is trained using resource management patterns from user data.

### BACKGROUND

The current invention relates to cloud platforms. Cloud computing has been a standard computing model for deploying applications in enterprise operations. Cloud computing delivers computing as a service where a plurality of resources including infrastructure, storage, network and software services hosted on cloud platforms, are provided for the needs of the enterprise organizations. The resources on the cloud platforms are available over communication networks and may be shared amongst a plurality of users.

### BRIEF DESCRIPTION OF THE DRAWINGS

The following detailed description references the drawings, wherein:

FIG. 1 is a block diagram of an example system for managing resources on one or more cloud platforms;

FIG. 2 is a flowchart of an example method for managing resources on one or more cloud platforms;

FIG. 3 is a flowchart of an example method for training a resource management model for managing resources on one or more cloud platforms;

FIG. 4 is an block diagram of a cloud management system for managing resources on one or more cloud platforms; and

FIG. 5 is a block diagram of an example controller with machine-readable medium for managing resources on one or more cloud platforms.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

The current invention discloses a method for managing a plurality of resources of a user on a multitude of cloud platforms. To deploy application workloads, cloud services from plurality of cloud platforms including public and private clouds are conventionally utilized. The cloud platforms provide the users with the ability to create resources computing resources like virtual machines (VMs), storage resources, network resources like domains, floating internet protocol addresses, etc., on demand accordingly to the workload demand. However, subsequent to the creation of additional resources, often it is difficult to identify the unused resources over a period of time. In cloud environments, there are limited options to discover and delete all the unused resource in the cloud. Most cloud platforms rely on utilization metrics to identify excess resources to be deleted or released. However, this is not effective in all cases and requires cloud administrator intervention. Moreover, since many users of an organization can consume these resources, it is very difficult to identify the unused resources in the cloud at an organization level and clean-up of those resources becomes a tedious activity to the cloud administrators of organizations. Though the cloud platform offers to the ability to deploy (or create) indefinite resources, there is a need for a mechanism to identify the unused resource and quick clean-up of those resources with minimal impact to the administrator as well as the organization which will help to reduce the cost of the cloud platforms. Accordingly the current disclosure describes a method and controller which actively monitor all the deployed resources, identifies the unused resources and cleans them. This is further explained below.

In an aspect, the current invention discloses a method for managing a plurality of resources associated with users, hosted in one or more cloud platforms. The method comprises receiving resource utilization data associated with the plurality of resources and event data associated the user application, identifying one or more resources to be freed, based on resource utilization data and event data using a resource management model, identifying a set of resources related with each resource from the one or more resources, and releasing each resource from the one or more resources and the set of related resources related with the corresponding each resource from the one or more resources.

The resource management model is trained using one or more resource management patterns from user data. Each resource management pattern is indicative of one or more events associated with one of deletion or release of resources. The user data includes time series data associated with user actions.

In an example, each resource from the one or more resources is dependent on a corresponding first set of resources. In another example, where the resource management model is a first model associated with a first set of one or more resource types, method further comprises providing a second model trained using user data associated with a second set of one or more resource types, and selecting one of the first model and the second model as the resource management model based on the user data. Selection between the first model and the second model as the resource management model is done by determining resource type information of a plurality of resources in the user data, and by assigning weights to the first model and the second model based on the resource type information.

In an example, the one or more cloud platforms comprises one or more of a public cloud platform, a private cloud platform and on-premise datacenter. In an example, the one or more resources includes one or more of floating internet protocol addresses, virtual machines, network interfaces, storage discs.

In another aspect, the current disclosure describes a method for training a resource management model, the resource management model for managing a plurality of resources associated with a user, hosted in one or more cloud platforms. The method comprises receiving user data associated with the plurality of resources, wherein the user data includes time series data associated with user actions associated with the plurality of resources types associated with the plurality of resources; identifying one or more resource management patterns from the user data; wherein each resource management pattern is indicative of one or more events associated with one of deletion or release of resources; and training a resource management model based on the one or more resource management patterns, wherein the resource management model is for managing the plurality of resources.

In another aspect, the current disclosure describes a cloud management system for managing resources on one or more cloud platforms. The cloud management system comprises a controller connected to the one or more cloud platforms. The controller receives resource utilization data associated with the plurality of resources and event data associated the user application, identifies one or more resources to be freed, based on resource utilization data and event data using a resource management model, identifies a set of resources related with each resource from the one or more resources and releases each resource from the one or more resources and the set of related resources related with the corresponding each resource from the one or more resources.

In another aspect, the current invention discloses a non-transitory machine-readable storage medium storing instructions that, when executed by at least one processor, cause the at least one processor to: receive resource utilization data associated with the plurality of resources and event data associated the user application; identify one or more resources to be freed, based on resource utilization data and event data using a resource management model; identify a set of resources related with each resource from the one or more resources; and release each resource from the one or more resources and the set of related resources related with the corresponding each resource from the one or more resources.

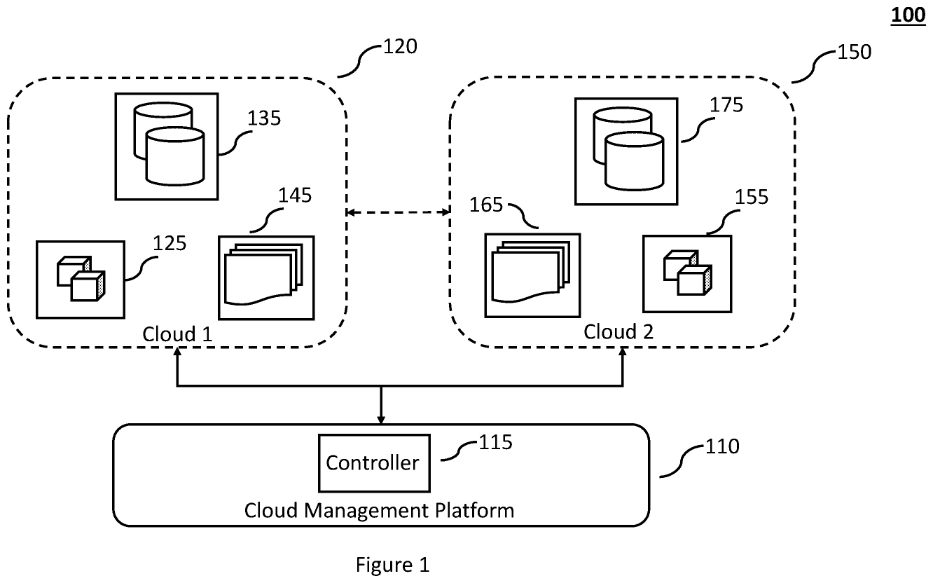

FIG. 1 is a block diagram of a system 100 for managing resources associated with one or more users, hosted on one or more cloud platforms (120 and 150). The system 100 includes a cloud management platform 110. The cloud management platform 110 is connected to one or more cloud platforms (shown in FIG. 1 as cloud 120 and cloud 150) over one or more networks. In an example, the cloud management platform 110 is connected to one or more cloud platforms (shown in FIG. 1 as cloud 120 and cloud 150) over the Internet.

Each cloud platform from the one or more cloud platforms (120 and 150) includes a plurality of resources. Each cloud platform node (120 and 150) includes a set of physical hardware that includes any number of processing resources (e.g., central processing units, graphics processing units, microcontrollers, application-specific integrated circuits, programmable gate arrays, and/or other processing resources, virtual machines), storage resources (e.g., random access memory, non-volatile memory, solid state drives, hard disk drives HDDs, optical storage devices, tape drives, and/or other suitable storage resources), network resources (e.g., Ethernet, IEEE 802.11 Wi-Fi, and/or other suitable wired or wireless network resources), I/O resources, and/or other suitable computing hardware. For example, FIG. 1 illustrates cloud 120 having virtual machines (shown as nodes 125), storage resources (shown as stores 135) and network interfaces (shown as interfaces 145). Similarly, FIG. 1 illustrates cloud 150 having virtual machines (shown as nodes 165), storage resources (shown as stores 175) and network interfaces (shown as interfaces 165).

Each cloud platform includes metadata associated with the resources of the user hosted on the corresponding cloud platform, which may be in the form logs and time series data specifying different attributes (e.g., application deployed, resource utilization, resource uptime, etc.) related to the resources of the user. Each cloud platform may be connected to cloud platforms and is capable transferring data and applications to the cloud platforms. In an example, a cloud platform may be a dedicated on-premise infrastructure. Similarly, in another example cloud platform may be a private or public cloud platform.

A plurality of user applications of multiple users may be deployed on the cloud platforms. User applications are deployed on the cloud platforms and are executed using the resources of the cloud platforms. Management of the resources associated with one or more users in the cloud platforms is done via a resource management controller 115. Such resource management controllers (illustrated in FIG. 1 as controller 115) enable deployment, monitoring, and management of the resources of the users on the cloud platforms. The controller 115 (also referred to as controller 115) is deployed on the cloud management platform 110 and connected to the plurality of cloud platforms (120 and 150).

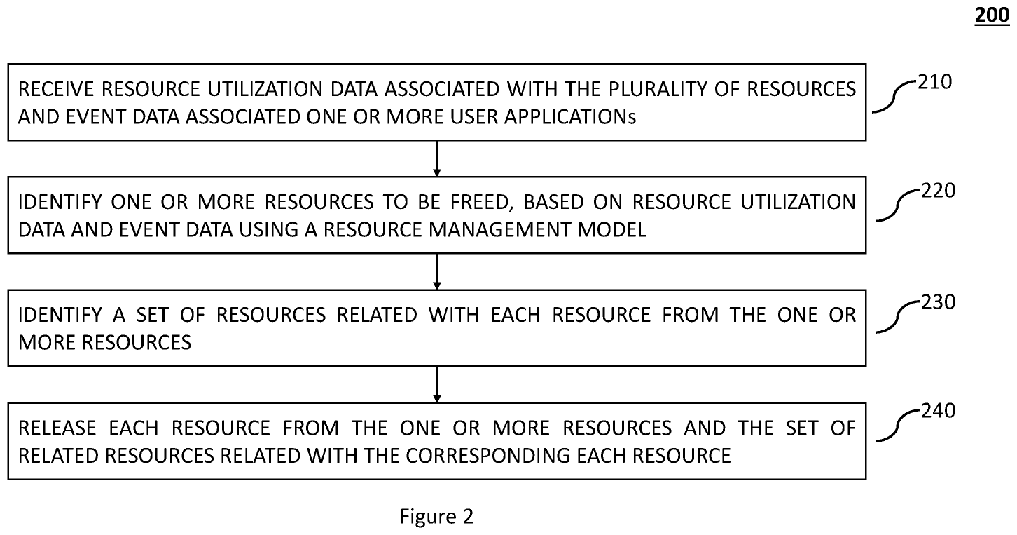

In an embodiment, each cloud platform includes a resource management agent which is responsible for communicating with the controller 115 for management of the resources of the users on the cloud platforms. In an aspect related to resource management, the controller 115 is responsible for detection of resources to be freed or deleted based on user behavior analysis and resource utilization. The controller 115 utilizing a resource management model identifies resources which may be freed up and identifies related resources used by the initially identified resources. Accordingly, the controller 115 deletes the identified resources and related resources and accordingly helps in reducing cloud related expense. This is further explained in the description of the FIG. 2.

FIG. 2 illustrates a method 200 for managing a plurality of resources associated with one or more users, hosted in one or more cloud platforms. At step 210, the controller 115 receives resource utilization data associated with the plurality of resources and event data associated the one or more user applications. In an example, the resource management agents of the cloud platforms communicate resource utilization and the event data of the resources and applications associated with at least one user. The controller 115 is linked to the at least one user and has access rights to monitor and manage resources associated with the at least one use on the one or more cloud rights for the execution of one or more user application. Resource utilization data includes information for each resource from the plurality of resources on the cloud platforms and includes resource uptime, resource utilization profile (utilization as time series data), related application identifier, resource cost, region of the resource, resource groups, etc. Event data includes information regarding the various events associated with the one or more user applications.

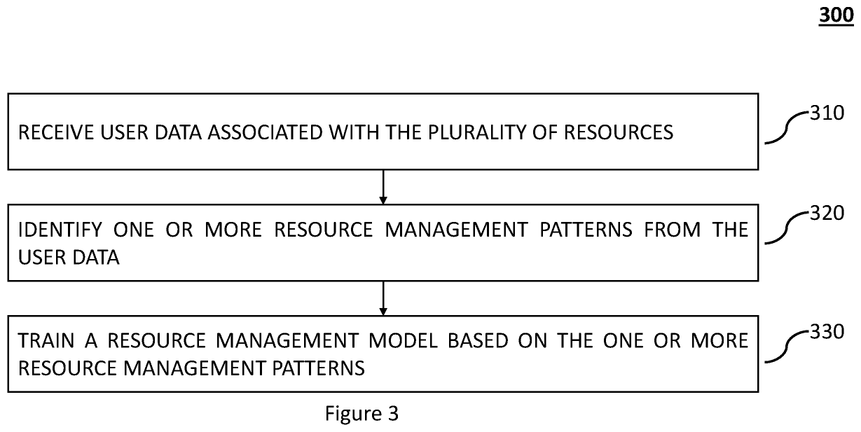

Subsequent to the receipt of the resource utilization and event data, at step 220 the controller 115 identifies one or more resources to be freed, based on resource utilization data and event data using a resource management model. The resource management model is a predictive model trained using user data. User data herein refers to user actions in relation to resources on the cloud platforms. User actions like resource deletion, resource suspension/powering on and off, resource capacity modification, resource starting, etc., is recorded by the cloud management platform 110. In an example, the resource management model is trained using one or more resource management patterns from user data. Each resource management pattern is indicative of one or more events associated with one of deletion or release of resources and wherein the user data includes time series data associated with user actions. In an example, the model is trained using resource cost and resource region. This is further explained in the description of FIG. 3.

Based on the resource management model, the controller 115 analyses the resource utilization data and event data to identify potential resources to be freed up or suspended (collectively referred to as released). For example, for a specific development application workload, resources are deployed during a work week and are released at the end of the work week. In an example, the resource management model learns this pattern and accordingly the controller 115 using the resource management model, identifies all development application workload and identifies resources related to the development application workloads as potential resources to be suspended.

At step 230, the controller 115 identifies a set of resources related with each resource from the one or more resources. In an example, each identified resource from step 220 is dependent/utilizes the set of resources and accordingly for release of the resource from step 220, release of the related set of resources may be required. For example, a virtual machine identified to be released may be using a network interface, an internet protocol address, etc. In order to effectively release the virtual machine, these set of resources would also be targeted for release. In an example, the controller 115 identifies the set of related resources on the basis of historic deletion error log data, and resource and application configuration data. For example, if a user initiated action in relation to resource deletion of a particular resource type had failed, one or more log entries would be created. These log entries would list resource and resource type to be deleted and the related resource and resource type due to which the operation failed. In an example, the controller 115 trains the resource management model using these log entries to identify the related set of resources for each resource type.

At step 240, the controller 115 releases each resource from the one or more resources and the set of related resources related with the corresponding each resource from the one or more resources. As mentioned above, release of a resource herein refers to deletion/suspension of the resource. For example, a virtual machine may be suspended in a cloud platform wherein the configuration of virtual machine is still retained which the actual computing resources are relinquished back to the resource pool in the cloud platform. In case of deletion, the actual resources are relinquished to the resource pool of the cloud platforms and the configuration data is deleted. In an example, prior to release of the resources, the controller 115 prompts for user input by displaying the list of resources to be released to the user. Based on the user input, the controller 115 releases the resources. By doing so, the user has an option to unselect one or more resources from being released. In an example the controller 115 calculates a savings cost based on the costs of the resource released and reports the costs saved to user. In an example, the controller 115 is able to identify resources across geographical regions and identify resource deletion based on user data and resource management patterns via the resource management model. In an example, controller 115 finds out the identical resources based on the load across the regions and between cloud platforms. If there are any resources with same workload, then the controller 115 will identify the regions associated with the resources with the same workload. If the resources in region1 and resources region2 are running the same workload but are using different image (t2.micro and m4.large), then resources will be identified for deletion and depending on the resource management model, the controller 115 will identify the resources to be deleted.

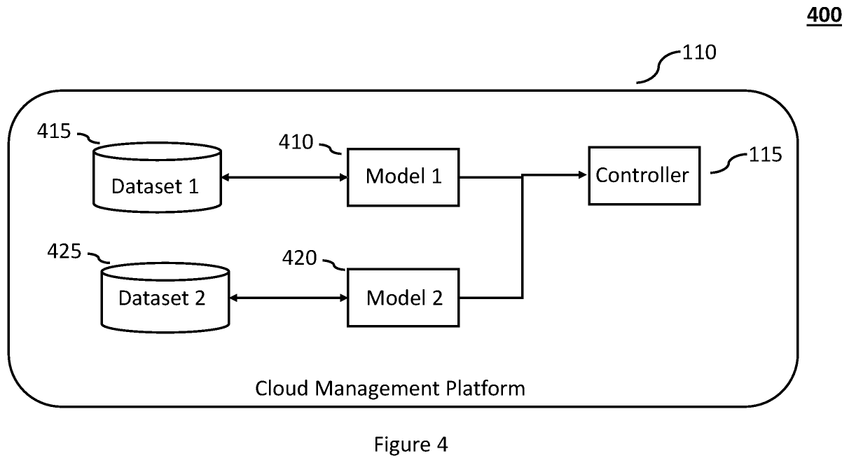

In an example, the cloud management platform 110 comprises a plurality of models (410 and 420) for resource management as shown in FIG. 4. Based on recent user data, either the first model 410 or the second model 420 is selected as the resource management model by the controller 115 and utilized in prediction of resources to be freed. The first model 410 is trained using the first dataset 415 and the second model 420 is trained using the second dataset 425. In an example, the first model is the default model and the first dataset is a training data set based on historic user data i.e. time series data associated with user actions in relation to the plurality of resources. Since this data is based on historic actions, one or more resources as included in the historic user data many not be in operation. Accordingly, for new resource types sufficient data may not be present for training the first model.

Accordingly, based on user actions post deployment, the controller 115 updates the training dataset 415 using the user data associated with the resource types already present in the training data set 415. After a predetermined time, the first model 410 is retrained using the updated training data set 415. If the resources types for the user actions post deployment are not present in the training data set (i.e. new resource types), the controller 115 creates a new dataset i.e. the second dataset 425. In an example, the second dataset is generated by combining the training data set and the user data associated with the new resource types. Then the controller 115 trains the second model 420 using the second data set 425. In an example, the controller 115 select one of the first and second models (410 and 420) on the basis of user data within a recent time window. For example, the controller evaluates the resource type information of a plurality of resources in the user data from a predetermined time window (for example one week from the current time instance) and assigns weights to the first model 410 and the second model 420 based on the resource type information. For example, if the first model 410 is trained for resource type virtual machines and the second model 340 is trained for resource type volumes, the user data for the last week is examined to identify if the user actions are primarily in relation to resource type virtual machines or volumes. For example, if there are ten user initiated resource deletion actions taken in the last week and 8 of these actions were in relation to virtual machines, the first model 410 is assigned a weight of 0.8 and the second model 425 is assigned a weight of 0.2. Accordingly, the controller 115 selects the first model 410 as the resource management model.

In another example, the controller 115 utilizes an ensemble model as the resource management model. The ensemble model comprises the first model 410 and second model 420. The recommendations from the first model 410 and second model 420 are considered in the ensemble model by using their calculated weights.

It is to be noted that FIG. 2 is explained using two cloud platforms (120 and 150), a plurality of cloud platforms may be monitored and managed by the controller 115. Additionally, as mentioned above, the cloud platform may include private, public hybrid clouds and on premise data centers. While the above example is explained using two models, a plurality of models in relation to the resource types may be utilized.

FIG. 3 illustrates a method 300 for training the resource management model used for managing a plurality of resources associated with a user, hosted in one or more cloud platforms. At step 310, the controller 115 receives user data associated with the plurality of resources, wherein the user data includes time series data associated with user actions associated with the plurality of resources types associated with the plurality of resources. User data herein refers to user actions in relation to resources on the cloud platforms. User actions like resource deletion, resource suspension/powering off, resource capacity modification, etc., is recorded by the cloud management platform 110. In an embodiment, the controller 115 also receives event data associated with the user applications.

At step 320, the controller 115 identify one or more resource management patterns from the user data. Each resource management pattern is indicative of one or more events associated with one of deletion or release of resources. From the user data and event data, the controller 115 determines one or more instances of resource deletion, modification or suspension and related events (referred to resource change events/actions) and user actions within a certain time window about each instance of resource change. Then, the controller 115 determines patterns around the one or more instances of resource change. These patterns are referred to as resource management patterns. For example, a resource management pattern may in relation to deletion events initiated by cloud administrators for resources of employees or users who are no longer active. In an example, when two users are inactivated in the cloud management system, their resources would be deleted by the cloud administrators. Accordingly, the controller 115 identifies the resource change events associated with the deletion of resources by the cloud administrators. Then, the controller 115 takes two snapshot of user data about the two resource change events for a window of two days. In the snapshots for both the resource change events, the user inactivation events are also present. This resource management pattern is identified by the controller.

At step 330, the controller 115 trains a resource management model based on the one or more resource management patterns. In an example, the controller 115 trains a plurality of models using the one or more resource management patterns. For example, the controller trains a first model with resource management patterns associated with a first resource type and the controller trains a second model with resource management patterns associated with a second resource type.

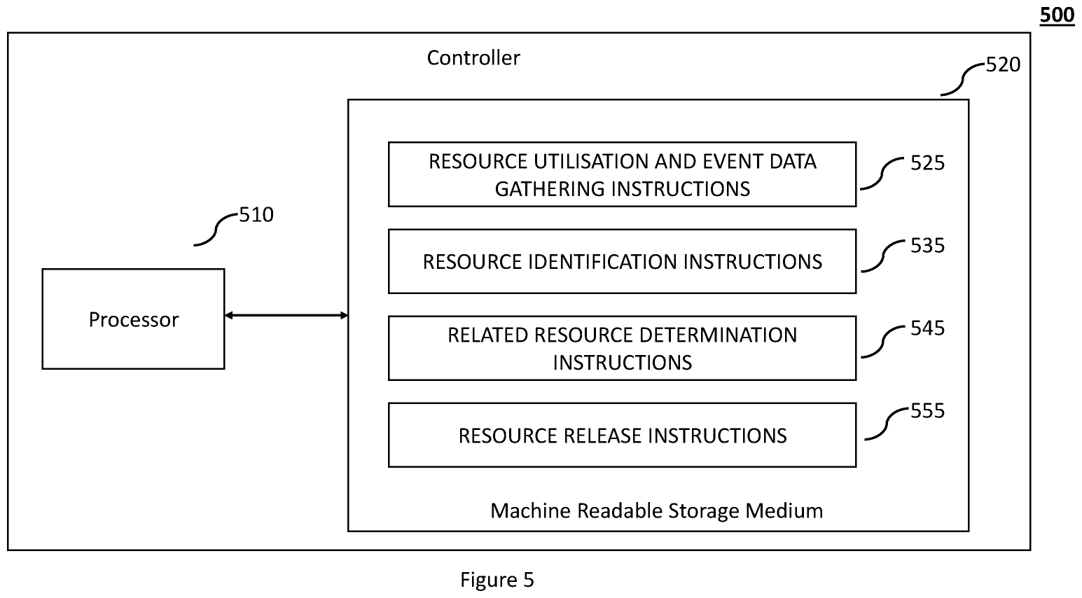

FIG. 5 is a block diagram of a controller 500 with machine-readable medium 520 for managing resources associated with one or more users, hosted on one or more cloud platforms (120 and 150). Machine-readable medium 520 is communicatively coupled to a processor 510. The controller 500 (machine-readable medium 520 and processor 510) may, for example, be included as part of cloud management platform 110 as illustrated in FIG. 1. Although the following descriptions refer to a single processor and a single machine-readable storage medium, the descriptions may also apply to a system with multiple processors and/or multiple machine-readable storage mediums. In such examples, the instructions may be distributed (e.g., stored) across multiple machine-readable storage mediums and the instructions may be distributed (e.g., executed by) across multiple processors.

Processor 510 may be central processing units (CPUs), microprocessors, and/or other hardware devices suitable for retrieval and execution of instructions stored in machine-readable storage medium 520. In the example shown in FIG. 5, processor 510 may fetch, decode, and execute machine-readable instructions 520 (including instructions 525-555) for managing resources associated with one or more users, hosted on one or more cloud platforms (120 and 150). As an alternative or in addition to retrieving and executing instructions, processor 510 may include electronic circuits comprising a number of electronic components for performing the functionality of the instructions in machine-readable storage medium 520. With respect to the executable instruction representations (e.g., boxes) described and shown herein, it should be understood that part or all of the executable instructions and/or electronic circuits included within one box may, in some examples, be included in a different box shown in the figures or in a different box not shown.

Machine-readable storage medium 520 may be any electronic, magnetic, optical, or other physical storage device that stores executable instructions. Thus, machine-readable storage medium 420 may be, for example, Random Access Memory (RAM), a nonvolatile RAM (NVRAM) (e.g., RRAM, PCRAM, MRAM, etc.), an Electrically-Erasable Programmable Read-Only Memory (EEPROM), a flash memory, a storage drive, an optical disc, and the like. Alternatively, machine-readable storage medium 520 may be a portable, external or remote storage medium, for example, that allows a computing system to download the instructions from the portable/external/remote storage medium. In this situation, the executable instructions may be part of an “installation package”. As described herein, machine-readable storage medium 520 may be encoded with executable instructions for managing resources associated with one or more users, hosted on one or more cloud platforms (120 and 150).

Referring to FIG. 5, resource utilization and event data gathering instructions 525, when executed by processor 510, may cause the processor 510 to receive resource utilization data associated with the plurality of resources and event data associated one or more user applications of one or more users. Resource identification instructions 535, when executed by the processor 510, may cause the processor 510 to identify one or more resources to be freed, based on resource utilization data and event data using a resource management model. Related resource determination instructions 545, when executed by the processor 510, may cause the processor 510 to identify a first set of resources related with each resource from the one or more resources. Resource release instructions 555, when executed by the processor 510, may cause the processors 510 to release each resource from the one or more resources and the first set of related resources related with the corresponding each resource from the one or more resources.

In an example, the non-transitory machine-readable storage medium 520 further includes instructions, that, when executed by at least one processor 510, cause the at least one processor to provide a first model 310 and second model 320, wherein the first model 310 is trained using user data associated with a first set of one or more resource types and the second model 320 is trained using user data associated with a second set of one or more resource types, and select one of the first model 310 and the second model 320 as the resource management model. In an example, instructions for selecting one of the first model 310 and the second model 320 as the resource management model, contains instructions that, when executed by at least one processor, cause the at least one processor to determine a count of resource type of a plurality of resources in the user data within a predetermined window, wherein the user data includes time series data associated with user actions associated with the associated with the plurality of resources within the predetermined window; and assign weights to the first model and the second model based on the count of resource type.

In an example, the non-transitory machine-readable storage medium 520 further includes instructions, that, when executed by at least one processor 510, cause the at least one processor to receive user data associated with the plurality of resources, wherein the user data includes time series data associated with user actions associated with the plurality of resources types associated with the plurality of resources; identify one or more resource management patterns from the user data; wherein each resource management pattern is indicative of one or more events associated with one of deletion or release of resources of a resource type from the plurality of resource types; and train a resource management model based on the one or more resource management patterns, wherein the resource management model is for managing the plurality of resources.

The foregoing disclosure describes a number of example implementations for managing a plurality of resources associated with one or more users, hosted in one or more cloud platforms. The disclosed examples may include systems, devices, computer-readable storage media, and methods for managing a plurality of resources associated with one or more users, hosted in one or more cloud platforms. For purposes of explanation, certain examples are described with reference to the components illustrated in FIGS. 1-5. The functionality of the illustrated components may overlap, however, and may be present in a fewer or greater number of elements and components. Further, all or part of the functionality of illustrated elements may co-exist or be distributed among several geographically dispersed locations. Additionally, while the current invention is described in the context of cloud platforms, the current invention may utilized in other environments such as distributed and fog computing, etc.

Moreover, the disclosed examples may be implemented in various environments and are not limited to the illustrated examples. Further, the sequence of operations described in connection with FIGS. 2 and 3 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for managing a plurality of resources associated with one or more users, hosted in one or more cloud platforms, the method comprising:
a. receiving resource utilization data associated with the plurality of resources and event data associated with one or more user applications of the one or more users;
b. identifying one or more resources to be freed, based on resource utilization data and event data using a resource management model;
c. identifying a first set of resources related with each resource from the one or more resources; and
d. releasing each resource from the one or more resources and the first set of related resources related with the corresponding each resource from the one or more resources;
wherein the resource management model is trained using one or more resource management patterns from user data; wherein each resource management pattern is indicative of one or more events associated with release of resources and wherein the user data includes time series data associated with user actions.

2. The method as claimed in claim 1, wherein each resource from the one or more resources is dependent on a corresponding first set of resources.

3. The method as claimed in claim 1, wherein the method further comprises
a. providing a first model and second model, wherein the first model is trained using user data associated with a first set of one or more resource types and the second model is trained using user data associated with a second set of one or more resource types, and
b. selecting one of the first model and the second model as the resource management model.

4. The method as claimed in claim 1, wherein the one or more cloud platforms comprises one or more of a public cloud platform, a private cloud platform and on-premise datacenter.

5. The method as claimed in claim 1, wherein the one or more resources includes one or more of floating internet protocol addresses, virtual machines, network interfaces, storage discs.

6. The method as claimed in claim 3, wherein selecting one of the first model and the second model as the resource management model further comprises
a. determining count of resource type of a plurality of resources in the user data within a predetermined window, wherein the user data includes time series data associated with user actions associated with the associated with the plurality of resources within the predetermined window; and
b. assigning weights to the first model and the second model based on the count of resource type.

7. A method for training a resource management model, the resource management model for managing a plurality of resources associated with one or more users, hosted in one or more cloud platforms, the method comprising:
a. receiving user data associated with the plurality of resources, wherein the user data includes time series data associated with user actions associated with the plurality of resources types associated with the plurality of resources;
b. identifying one or more resource management patterns from the user data;
wherein each resource management pattern is indicative of one or more events associated with one of deletion or release of resources for a resource type from the plurality of resource types; and
c. training the resource management model based on the one or more resource management patterns, wherein the resource management model is for managing the plurality of resources.

8. A cloud management system for managing resources on one or more cloud platforms, the cloud management system comprising:
a controller connected to the one or more cloud platforms, the controller (115) for:
a. receiving resource utilization data associated with the plurality of resources and event data associated one or more user applications of one or more users;
b. identifying one or more resources to be freed, based on resource utilization data and event data using a resource management model;
c. identifying a first set of resources related with each resource from the one or more resources; and
d. releasing each resource from the one or more resources and the first set of related resources related with the corresponding each resource from the one or more resources;
wherein the resource management model is trained using one or more resource management patterns from user data; wherein each resource management pattern is indicative of one or more events associated with release of resources and wherein the user data includes time series data associated with user actions.

9. The cloud management system as claimed in claim 8, wherein each resource from the one or more resources is dependent on a corresponding first set of resources.

10. The cloud management system as claimed in claim 8, wherein the controller is further for
a. providing a first model and second model, wherein the first model is trained using user data associated with a first set of one or more resource types and the second model is trained using user data associated with a second set of one or more resource types, and
b. selecting one of the first model and the second model as the resource management model.

11. The cloud management system as claimed in claim 8, wherein the one or more cloud platforms comprises one or more of a public cloud platform, a private cloud platform and on-premise datacenter.

12. The cloud management system as claimed in claim 8, wherein the one or more resources includes one or more of floating internet protocol addresses, virtual machines, network interfaces, storage discs.

13. The cloud management system as claimed in claim 10, wherein the controller selects one of the first model and the second model as the resource management model by
a. determining a count of resource type of a plurality of resources in the user data within a predetermined window, wherein the user data includes time series data associated with user actions associated with the associated with the plurality of resources within the predetermined window; and
b. assigning weights to the first model and the second model based on the count of resource type.

14. The cloud management system as claimed in claim 7, the controller further for:
a. receiving user data associated with the plurality of resources, wherein the user data includes time series data associated with user actions associated with the plurality of resources types associated with the plurality of resources;
b. identifying one or more resource management patterns from the user data; wherein each resource management pattern is indicative of one or more events associated with one of deletion or release of resources of a resource type from the plurality of resource types; and
c. training the resource management model based on the one or more resource management patterns, wherein the resource management model is for managing the plurality of resources.

15. A non-transitory machine-readable storage medium storing instructions that, when executed by at least one processor, cause the at least one processor to:
a. receive resource utilization data associated with the plurality of resources and event data associated one or more user applications of one or more users;
b. identify one or more resources to be freed, based on resource utilization data and event data using a resource management model;
c. identify a first set of resources related with each resource from the one or more resources; and
d. release each resource from the one or more resources and the first set of related resources related with the corresponding each resource from the one or more resources;
wherein the resource management model is trained using one or more resource management patterns from user data; wherein each resource management pattern is indicative of one or more events associated with release of resources and wherein the user data includes time series data associated with user actions.

16. The non-transitory machine-readable storage medium as claimed in claim 15, wherein each resource from the one or more resources is dependent on a corresponding first set of resources.

17. The non-transitory machine-readable storage medium as claimed in claim 15, wherein the non-transitory machine-readable storage medium further includes instructions, that, when executed by at least one processor, cause the at least one processor to
a. provide a first model and second model, wherein the first model is trained using user data associated with a first set of one or more resource types and the second model is trained using user data associated with a second set of one or more resource types, and
b. select one of the first model and the second model as the resource management model.

18. The non-transitory machine-readable storage medium as claimed in claim 15, wherein the one or more cloud platforms comprises one or more of a public cloud platform, a private cloud platform and on-premise datacenter.

19. The non-transitory machine-readable storage medium as claimed in claim 17, wherein includes instructions for selecting one of the first model and the second model as the resource management model, contains instructions that, when executed by at least one processor, cause the at least one processor to
a. determine a count of resource type of a plurality of resources in the user data within a predetermined window, wherein the user data includes time series data associated with user actions associated with the associated with the plurality of resources within the predetermined window; and
b. assign weights to the first model and the second model based on the count of resource type.

20. The non-transitory machine-readable storage medium as claimed in claim 15, wherein the non-transitory machine-readable storage medium further includes instructions, that, when executed by at least one processor, cause the at least one processor to
a. receive user data associated with the plurality of resources, wherein the user data includes time series data associated with user actions associated with the plurality of resources types associated with the plurality of resources;
b. identify one or more resource management patterns from the user data; wherein each resource management pattern is indicative of one or more events associated with one of deletion or release of resources of a resource type from the plurality of resource types; and
c. train a resource management model based on the one or more resource management patterns, wherein the resource management model is for managing the plurality of resources.
